(19) United States
(12) Patent Application Publication
(10) Pub. No.: US 2004/0098915 A1
(43) Pub. Date: May 27, 2004

(54) Residential handicap accessible door

(76) Inventor: R. Peter Baldry, Acton, ME (US)

Correspondence Address: Frederick R. Cantor, Esq., Post Office Box 87, SOUTH FREEPORT, ME, 04078, US

(21) Appl. No.: 10/302,144

(22) Filed: Nov. 22, 2002

(51) Int. Cl. E05F 15/02

(52) U.S. Cl. 49/339; 49/340; 49/343; 49/280

(57) ABSTRACT

A fully automatic hinged residential door system is described suitable for quadriplegics, or other persons confined to wheelchairs. A wireless command operated through a hand held or mounted transmitter instigates a series of operations which unlocks the entry way, turns on appropriate lights, opens the door through at least ninety degrees, allows entry or egress, and responds to close commands in manual or automatic mode. The door is fail safe and can be operated automatically during power outages. A means of manual key or code operation is maintained. The system comprises a low voltage power supply, an opening device comprising electric motors, light controlling apparatus, a locking and unlocking device, force limiting hardware, and a movable door sill. The unit is compatible with all existing hinged door openings and can be retrofitted, or used as part of new construction.

### FIELD OF THE INVENTION

This invention relates to a residential or office building entry access structure, and more particularly to a building entry door that can be opened or closed by a person seated in a wheelchair (or by other persons on foot). The entry door can also be located on a single family residence, or at an apartment in a multi-resident apartment building.

### BACKGROUND OF THE INVENTION

Since Congress passed the American Disabilities Act several years ago, the result has been a vast improvement in providing easy access to those Americans who are physically challenged, especially persons confined to wheelchairs. Where significant improvements have been made to lowering curbs in city streets, and providing wheel chair ramps improving building access, by far the most rewarding have been the provision of automatic access doors into government and public buildings as mandated by the Act.

Unfortunately, when the same physically challenged persons return home they are faced with the same problems as they always faced, that of getting a wheelchair into the house or apartment. This probably includes negotiating a ramp to the front door, fumbling for keys, unlocking and opening the door against various forces which react against the chair, then finally gaining access to the entry way. Often, the wheelchair now has to be turned around in order to close the door and apply the lock. Further, the wheelchair now has to be turned again to actually go into the room of choice.

In order to ease the burden on the wheelchair bound, the present invention provides an automatic door that would be affordable to all, would fit conventional “residential” homes without significant retrofits, and would offer all the advantages of existing technologies available.

### SUMMARY OF THE INVENTION

In one particular form, the invention includes an upstanding door-support frame suitably secured in a building wall to form an access opening between a residential living area and the exterior pedestrian area. A generally conventional door is hingedly attached to the frame for horizontal swinging movement between a closed position within the frame and an open position extending ninety degrees (or more) away from the frame. An electrically-operated power mechanism is provided for moving the door between its open and closed positions.

In order to permit a wheelchair occupant to control the door-operating mechanism a wireless radio transmitter-receiver system is provided. The radio transmitter is ordinarily a manually-operated device carried by the wheelchair occupant. The radio receiver is located on the door frame in electrical connection with an electrical motor that moves the door between its open and closed positions.

It is necessary that in a residential environment the door be securely locked (preferably by a deadbolt lock), in order to prevent would-be intruders from forcing the door open. A door lock is also desired for securely retaining the door in a fixed closed position in pressure engagement with weatherstripping on the door frame, in order to prevent wind, cold air or rain from the migrating through the doorway into the residence.

Unfortunately, most conventional door locks are not capable of remote operation, as would be necessary for achievement of a door lock actuation by a wheelchair occupant. In the present invention, a conventional key-operated lock (preferably a deadbolt lock) is provided on the door. The associated keeper on the door frame is specially constructed so that it can be remotely moved (or operated) between a retracted position out of engagement with the lock bolt and an operating position engageable with the lock bolt.

A wheelchair occupant is enabled to remotely operate the keeper between the retracted position and the operating position, so he or she can lock or unlock the door while seated in a wheelchair that is spaced away from the door lock. The door lock-unlock operations can be programmed with the door-moving operations as part of an overall cycle, which includes unlocking the door, moving the door from the closed position to the open position, providing a time delay for passage of the wheelchair through the doorway, moving the door to the closed position, and locking the door in its closed position.

In most residential entry door installations, the lower edge of the door is sealed by a sill that may include a weatherstrip raised above the interior floor surface contiguous with the sill. The reason for raising the weatherstrip surface is to eliminate frictional drag between the door lower edge and floor surface as the door swings from the closed position to the open position. The raised sill surface presents a problem as regards wheelchair movement through the doorway.

The wheelchair is usually moving slowly while it is being maneuvered through the doorway, since there is only a relatively small side clearance between the arms of the wheelchair and the jamb surfaces of the door frame. The wheelchair occupant usually keeps the wheelchair moving slowly in order to guide the wheelchair accurately through the doorway without bumping against the jamb surfaces. The raised sill provides an obstruction to slow movement of the wheelchair so that in some situations the person might experience some difficulty in guiding and propelling the wheelchair wheels across a raised sill.

In the present invention the door sill is power-operated between a raised position engaged with the lower edge of the door and a lowered position aligned with the contiguous floor surface. While the door is in the closed position the door sill is in the raised position sealing the joint with the door lower edge against wind, drafts or rain. Prior to opening the door, the door sill is lowered to a position aligned with the floor surface, so that the door can be opened without encountering any frictional drag from the sill or floor surface. The wheelchair can be wheeled through the doorway without being obstructed by the door sill; i.e. the wheels of the wheelchair roll easily across the lowered sill.

After the door has been moved to the closed position the door sill is powered upwardly to the door-sealing position. Preferably the operation of raising or lowering the doorsill is performed as part of the programmed cycle that includes unlocking or locking the door, and opening or closing the door in a sequential fashion. The entire cycle can be controlled by the wheelchair occupant (via the radio transmitter-receiver signal) without assistance by any other person.

A principal advantage of the power-operated door sill is that the sill can be in a lowered position at the instant when the door is being moved to or from the closed position. This removes frictional drag from the slow-moving door, thereby lessening the power requirement for moving the door.

To achieve a satisfactory utilization of the entry access structure the apparatus should be capable of use by wheelchair occupants and also by persons approaching the door on foot. This is necessary, or advantageous, because any given residence can be occupied by persons requiring wheelchair assistance and by persons not requiring such assistance. In the present invention the door-moving mechanism and the door-locking mechanism are designed so as to operate alternatively by persons in wheelchair and by persons on foot.

As regards versatility of the door-moving mechanism, the power source (electric motor) may be connected to a drive unit through a disengageable clutch. When the clutch is in the disengaged condition, a person on foot can open or close the door without resistance from the drive unit; the drive unit is in a free-wheeling mode offering negligible resistance to door-movement. When the clutch is in the engaged condition the power source can be energized (by a wheelchair occupant) to move the door via the drive unit.

As regards versatility of the door-lock mechanism, the present invention uses a conventional key-operated lock in combination with a power-operated keeper. An electric motor is operatively connected to the keeper for moving the keeper between a retracted position (out of the path of the lock bolt) and an operating position (capable of capturing the lock bolt). The motor can be energized remotely (by a wheelchair occupant) to move the keeper to the retracted position, thereby effectively unlocking the door. When the keeper is moved to its operating position, the door can be locked or unlocked, using a conventional key. The lock mechanism is designed so that it can be operated either electrically (by a wheelchair occupant) or manually (by a person on foot).

The building access structure of the present invention can have the following features or characteristics:

1. A residential door specifically designed for the physically challenged resident, yet compatible for all residents.

2. A door capable of being opened by a signal received from a key chain wireless transmitter or other hand held device, but not limited to such.

3. An electronic security system utilizing rolling codes and compatible with all existing home security systems.

4. A low voltage power operated door opener, with battery backup during power outages maintaining all features fully operational.

5. A miniature door operating mechanism mounted within the confines of the door yet not mounted on the door itself.

6. A power operated lock mechanism capable of providing strong power assistance both in the opening mode and closing mode.

7. A mechanism capable of compressing the door seals, which may contain heating elements, to ensure weather resistance.

8. A device to illuminate the entry way during operation, and means of holding the illumination for specific periods.

9. A mechanism capable of lowering the thresh hold during the opening process thereby providing a perfectly level entry way into the residence.

10. A mechanism capable of raising the thresh hold after closing the door to effect a weather seal.

11. A mechanism able to open an unimpeded door in a time not to exceed four seconds.

12. A mechanism capable of closing an unimpeded door in a time not to exceed four seconds.

13. A safety mechanism allowing the dissipation of energy if any body, or immovable object, obstructs the opening or closing of the door.

14. A safety mechanism to first stop, and then reverse the drive after a predetermined time, in the event that a command cannot be executed.

15. A complete pre-assembled door unit shipped as one unit ready for installation, and ready for immediate operation upon completion.

16. A complete pre-assembled door unit requiring only the connection to a 110 volt power supply, or, connection to a solar cell array.

Further features of the invention will be apparent from the attached drawings and description of an illustrative embodiment of the invention.

### BRIEF DESCRIPTION OF THE DRAWINGS

FIG. 1 is an elevational view of a residential building entry access structure of the present invention, taken from inside the residence.

FIG. 2 is a fragmentary sectional view taken on line 2-2 in FIG. 1.

FIG. 3 is a sectional view taken through a drive unit used in the FIG. 1 structure for opening or closing a door.

FIG. 4 is a sectional view taken on line 4-4 in FIG. 3.

FIG. 5 is a sectional view taken on line 5-5 in FIG. 3.

FIG. 6 is a schematic illustration of a linkage that can be used in the door-moving mechanism depicted in FIG. 1.

FIG. 7 is a cross sectional view taken on line 7-7 in FIG. 1, and showing a door-locking mechanism employed in practice of the invention.

FIG. 8 is a sectional view taken on line 8-8 in FIG. 7.

FIG. 9 is a front elevational view of the lock mechanism illustrated in FIG. 7.

FIG. 10 is a longitudinal sectional view taken through a power-operated door sill (thresh hold) employed in the FIG. 1 building entry access structure.

FIG. 11 is a transverse sectional view taken on line 11-11 in FIG. 10.

FIG. 12 is a chart depicting a sequence of events that can occur during a door-opening cycle and a door-closing cycle, according to the present invention.

### DESCRIPTION OF A PREFERRED EMBODIMENT OF THE INVENTION

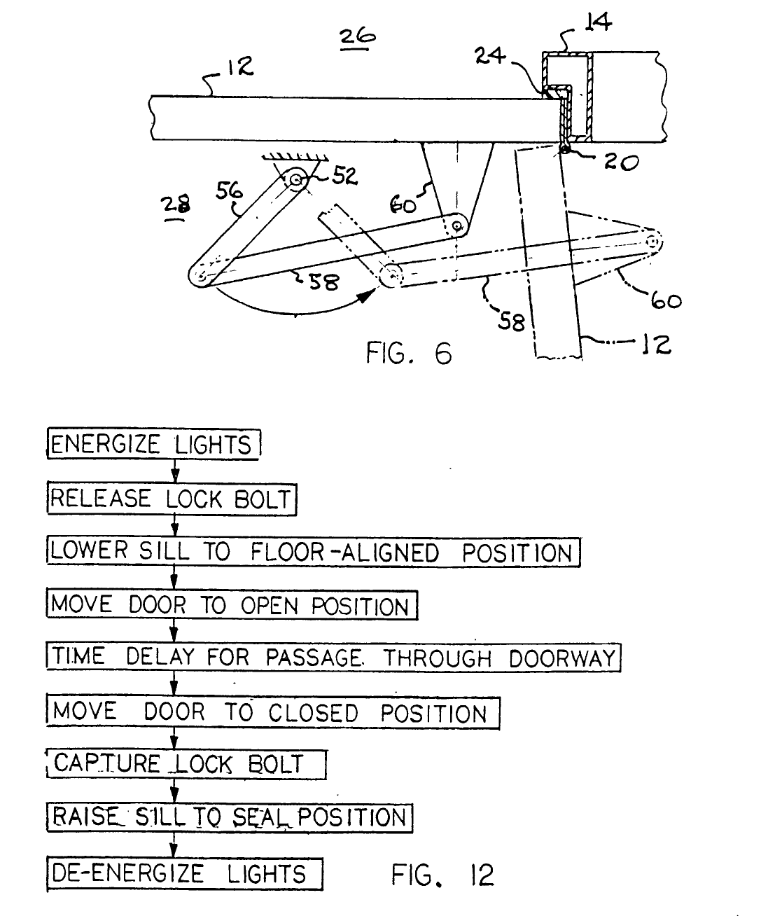

Referring to FIG. 1, there is shown a building entry access structure that includes an upstanding door-support frame 10, a door 12 hingedly attached to the frame, and a mechanism for controlling the swinging motion of the door between an open position and a closed position. The door is shown in the closed position in FIG. 1. FIG. 6 fragmentarily shows the door 12 in two positions, i.e. closed (in full lines) and open (in dashed lines). The door swings through an arc of at least ninety degrees (and preferably about one hundred ten degrees) when moving from the closed position to the open position.

Referring again to FIG. 1, door-support frame 10 includes two upstanding side frame members (or jambs) 14 and 16, and an overhead frame member 18 that cooperatively form an open doorway (or passage) when door 12 is in the open position. The door is swingably attached to side frame 14 by conventional hinges 20. A door sill 22 extends between the side frames below the lower edge of the door.

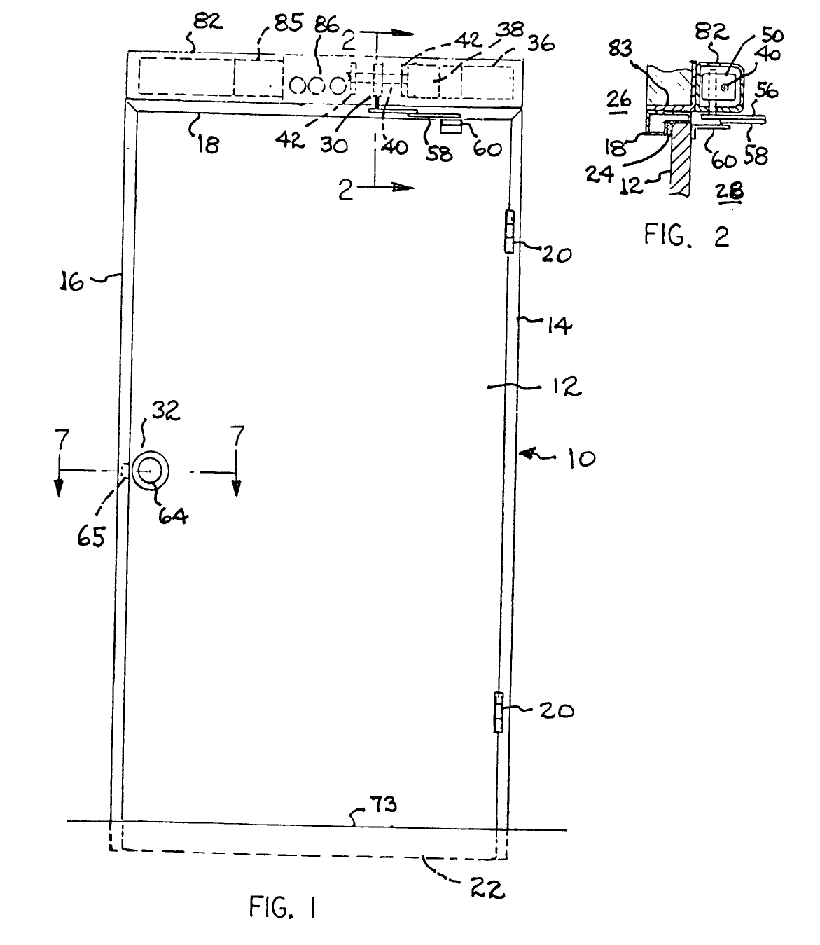

The door shown in FIG. 1 swings inwardly into the residence when moving from the closed position to the open position. In the closed position the door seats against weatherstrip elements 24 carried by frames 14, 16 and 18. Illustrative weatherstrip elements are shown in FIGS. 2, 6 and 7. The function of such weatherstrip elements is to prevent wind or rain from migrating from the external atmosphere 26 into the residential (living) space 28 when the door is in the closed position.

The door close-door open activity is controlled, or affected by three cooperating mechanisms that are collectively as a control means. This control means includes an electrically-operated means 30 for moving the door between the closed and open positions, an electrically-operated lock means 32 for retaining the door in the closed position, and a power-operated means 34 for raising or lowering the door sill 22. FIGS. 10 and 11 illustrate the principal features of the power-operated door sill moving means 34.

The electrically operated door-moving means 30 includes a reversible electric motor 36 (FIG. 1) operatively connected to a disengageable clutch 38, whose output member drives a rotary screw 40. Clutch 38 can be an electromagnetic clutch that effectively disconnects screw 40 from motor 36 when the clutch is electrically de-energized.

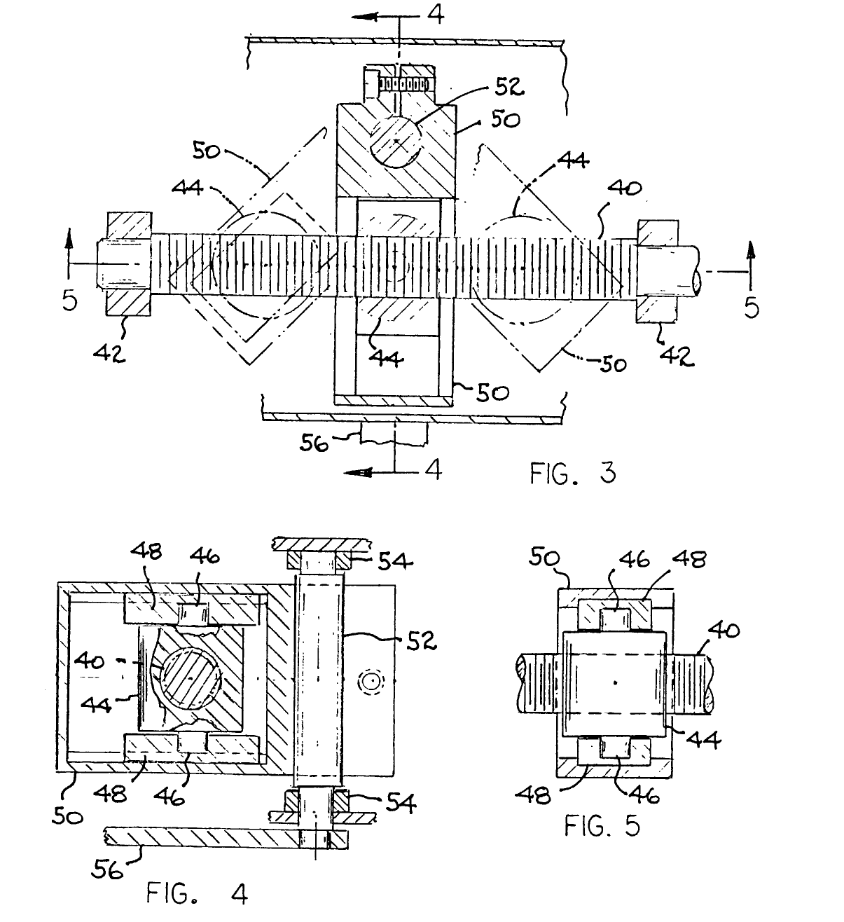

FIGS. 3 through 5 illustrate the general operation of rotary screw 40 and associated drive componentry. Bearings 42, 42 mount screw 40 for reversible rotation around the screw axis, whereby a nut 44 in mesh with the screw is enabled to move left or right on the screw to two limiting position, as shown in dashed lines in FIG. 3.

Nut 44 has two stub shafts 46 that can rotate within circular sockets formed in shoes 48 that are slidably positioned in guideways formed in a housing 50. Housing 50 is suitably attached to a vertical shaft 52 that is supported on upper and lower bearings 54. As shown in FIG. 4, the lower end of shaft 52 extends through the lower bearing 54 so as to have a fixed connection with a lever 56.

The described componentry translates rotary motion of screw 40 into an arcuate swinging motion of lever 56. During this process housing 50 moves in an arc around the axis of shaft 52, as indicated by the dashed lines in FIG. 3. FIG. 3 shows housing 50 and nut 44 in an intermediate position midway between the two limiting positions depicted in dashed lines.

More particularly, as screw 40 rotates on the screw axis, nut 44 advances along the screw (right or left), while shoes 48 slide within housing 50 toward or away from the axis of shaft 52. During this process housing 50 swings around the shaft 52 axis. The shaft imparts a swinging motion to the associated lever 56. In the apparatus depicted in FIGS. 3 through 5, lever 56 moves through an arc of about ninety degrees in response to the permitted travel of nut 44 along rotary screw 40.

FIG. 6 illustrates the manner in which movement of lever 56 is translated into movement of door 12. Lever 56 is pivotably connected to a link 58 that is in turn pivotably connected to an arm structure 60 that extends outwardly from door 12 near the door upper edge. As lever 56 swings through an arc of approximately ninety degrees around the axis of shaft 52, link 58 moves door 12 from the closed position to the open position. During reverse arcuate movement of lever 56 the door is returned from the open position to the closed position.

As shown in FIG. 2, lever 56 and 58 are located in planes slightly above the upper edge of door 12, so that the door can pass underneath the lever-link assembly during door movement.

By way of summarizing the door-open and door-close operations, electrical energization of reversible motor 36 and clutch 38 produces reversible rotation of screw 40. Nut 44 is moved along the screw to produce a swinging motion of housing 50 around the shaft 52 axis. The shaft is thus rotated to impart an arcuate motion to lever 56. As shown in FIG. 6, the lever moves link 58 that in turn swings door 12 about the hinge 20 axis between the open and closed positions. Motor 36 rotation in one direction opens the door; motor 36 rotation in the opposite direction closes the door. The line of action of link 58 can be offset a considerable distance from the hinge 20 axis, to produce a relatively great door closing force for any given motor 36 power.

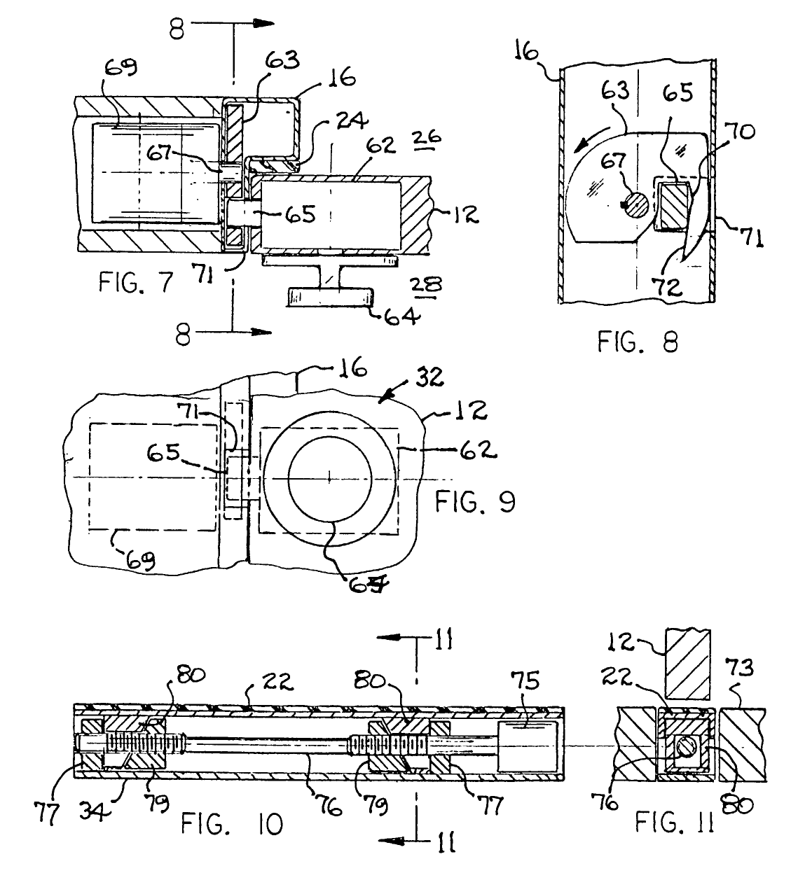

Referring to FIGS. 7 through 9, there is shown an electrically-operated lock means 32 utilized in the present invention. The lock means includes a conventional key-operated lock 62 carried on door 12 and a specially constructed keeper 63 mounted on door jamb (frame) 16.

Lock 62 can be a deadbolt lock having a key-operation slot facing the external atmosphere 26, and a manual (handle) operator 64 facing the residential space 28. A person can turn handle 64 to move lock bolt 65 outwardly beyond the door edge or inwardly into the door. Alternately, a person located outside the door can use a key to operate lock bolt 65. As shown in FIGS. 7 and 9, the lock bolt is extended beyond the door edge into jamb 16 so as to be captured by keeper 63. In this position the door is in a locked condition. Lock bolt 65 can be manually moved within the major plane of the door to a concealed position entirely within the door; in such a position the door is unlocked.

Keeper 63 is shown as a flat disk having a fixed connection with a support shaft 67, whereby the keeper can be rotated around the shaft axis between an operating position (as shown) and a retracted position. A reversible servo motor 69, or other electrical power operator, is connected to shaft 67 to move keeper disk 63 to the two limiting. In the illustrated arrangement the keeper disk 63 rotates through an arc of approximately ninety degrees between its limiting positions; however, with a reconfigured disk construction a greater arc could be used.

As shown in FIG. 8, keeper disk 63 has a notch 70 in its edge surface that has a shape conforming to the cross section of lock bolt 65. When the keeper is in the FIG. 8 position, and the lock bolt is extended beyond the edge of door 12 (as shown in FIG. 7) the bolt is captured by the keeper so that door 12 is retained in the closed position; the door cannot be opened except by manually retracting lock bolt 65 into the door (by handle 64 or by the aforementioned key).

Jamb 16 has an opening 71 in registry with an edge area of keeper disk 63, so that when motor 69 is energized to rotate the keeper disk counterclockwise (from the FIG. 8 condition) the disk is no longer captively engaged with lock bolt 65. The door can then be opened, even though lock bolt 65 is in the extended (locking) position. During movement of the door away from the closed position bolt 65 moves transversely through opening 71 in the jamb 16 wall.

The facilitate a weathertight seal between door 12 and the weatherstrip 24 on jamb 16, it is necessary that lock bolt 65 have a close snug fit on the surface of keeper notch 70. In order to promote such a snug fit, notch 70 is configured with a cam surface 72 that incrementally recedes away from the axis of shaft 67 toward the mouth of the notch. As keeper disk 63 moves in a clockwise direction toward the FIG. 8 condition, cam surface 72 exerts a cam force on the right edge of lock bolt 65 so as to bias the door slightly toward a closed condition having pressure contact with weatherstrip 24 on jamb 16. This action tends to ensure a weathertight seal between the door and the weatherstrip when the door is in the closed condition.

By way of summarizing the door lock-unlock action, when keeper 63 is in the FIG. 8 condition the lock mechanism can be operated manually in normal fashion. A person can lock or unlock the door, using either handle 64 or a key (inserted into the lock from the external area 26).

When keeper 63 is rotated counterclockwise from the FIG. 8 condition, the lock bolt 65 is no longer captively engaged by keeper notch 70. The door can be freely moved from the closed condition, even though the locking bolt is in the extended (locking) position depicted in FIG. 7.

As noted previously, reversible electric motor 69 is used for moving keeper 63 between the retracted and operating positions. Motor 69 operation can be remotely controlled by a person seated in a wheelchair.

Referring to FIGS. 10 and 11, there is shown a door sill 22 that would in practice be located within the plane of door-support frame 10 below the lower edge of door 12, when the door is in the closed position. Door sill 22 is movably supported within a recess in floor surface 73 so as to be movable up or down a slight distance (usually about one inch). When the door sill is moved up (from the FIG. 11 position) the sealing material on the door sill engages the door lower edge to form a weathertight seal. When door sill 22 is lowered to the FIG. 11 condition the door is freed from frictional contact with the door sill so as to be freely movable from the closed condition. By lowering the doorsill to the FIG. 11 position it is possible to reduce the motor requirement for moving the door to the closed position (i.e. the power rating and size of motor 36). The lowered door sill is also advantageous in that the upper surface of the door sill is aligned with the contiguous floor surface 73, so that a wheelchair can readily roll over the door sill, without being obstructed (by a raised door sill).

In the arrangement of FIGS. 10 and 11, door sill 22 is moved up or down by means of a reverible servo motor 75 that has a drive connection with a rotary screw 76. Stationary bearings 77 support the screw for reversible rotation around the screw axis.

One area of the screw has a right hand thread, and another area of the screw has a left hand thread. Nuts 79 are correspondingly threaded, so that when the screw is rotated in one direction the nuts move toward each other, and when the screw is rotated in the other direction the nuts 79,79 move away from each other.

As shown in FIG. 10, nuts 79 have acutely angled cam surfaces that slidably mate with angularly directed surfaces on cam followers 80, 80 carried by door sill 22. With the componentry in the FIG. 10 position, motor 75 can be energized to turn screw 76, whereby nuts 79 move away from one another to exert cam forces on the cam followers 80, thereby raising door sill 22 to a position engaged with the lower edge of door 12. By energizing motor 75 in the reverse direction, it is possible to gravitationally lower the door sill to the illustrated position. Motor 75 can be controlled remotely, e.g. by a person seated in a wheelchair.

As previously noted, the door open-close cycle involves three cooperating mechanisms, i.e. the door lock mechanism 32 shown in FIGS. 7 through 9, the door-moving mechanism 30 shown in FIGS. 1 and 3 through 6, and the door sill elevating-lowering mechanism shown in FIGS. 10 and 11. These three mechanisms can be remotely controlled, e.g. by a person seated in a wheelchair. A radio transmitter held by a wheelchair occupant transmits a radio signal to a radio receiver located on a door-support frame 10 in an elongated box-like housing 82 suitably mounted on overhead frame member 18 (FIG. 1). As shown in FIG. 2, housing 82 is secured to frame member 18 by means of an angle bracket 83. Other mounting devices can be employed.

The above-mentioned radio receiver can be located within an electrical control or programming unit 85 that supplies control signals to motors 36, 69 and 75, whereby the associated mechanisms can be powered in a desired sequence for moving door 12 from its closed position to its open position, and then back to the closed position. The cycle can include a delay period between the door-opening portion of the program and the door-closing portion of the program, in order to permit passage of a wheelchair through the open doorway.

As ancillary feature of the invention, an overhead lighting means 86 (FIG. 1) may be provided in housing 82 for illuminating the open doorway while the door is in the open position. The lower wall area of housing 82 directly below lighting means 86 will be transparent in order to achieve the desired illumination of the doorway.

As a further feature of the invention, a reserve standby electrical power source 87 can be located within housing 82 for supplying electrical power to the three servo motors 36,69 and 75, and the lighting array 86. Typically, power source 87 will include one or more D.C. batteries. The servo motors will preferably be direct current-operated.

FIG. 12 shows a typical sequence of actions generated, or directed by programming unit, when triggered into action by the remote radio signal. As noted previously, the radio signal can be generated by a hand-held transmitter operated by a wheelchair occupant. The sequence of actions includes releasing the lock bolt (using servo motor 69), lowering sill 22 out of engagement with door 12 (using servo motor 75), moving door 12 to the open position (using motor 36, providing a time delay for enabling a wheelchair to pass through the open doorway, moving door 12 to the closed position (using motor 36), energizing motor 69 to cause keeper 63 to capture lock bolt 65, and energizing motor 75 to raise sill 22 into sealing engagement with door 12.

The time delay period shown in FIG. 12 can be a fixed time period programmed into control unit 85. Alternately, the time delay period can be varied manually, e.g. by generating a first radio signal for opening the door, waiting a suitable length of time, and then generating a second radio signal for closing the door.

In a wheelchair operation there is a possibility that the door might inadvertently strike the wheelchair, should the wheelchair be too close to the door prior to the door-open action, or in the event that the wheelchair be delayed in the open doorway while the door is being closed. To prevent damage to the wheelchair or injury to the wheelchair occupant, the electrical control system preferably includes motor control features for stopping or reversing motor 36 should the door encounter an obstruction while the door in being opened or closed. Control systems that might be used are shown in U.S. Pat. No. 5,278,480 to J. S. Murray, or U.S. Pat. No. 4,980,618 to R. D. Milnes, or U.S. Pat. No. 4,924,159 to R. Olsen, or U.S. Pat. No. 5,081,406 to Hughes et al.

A feature of this invention is that the door-operating cycle can be controlled electrically by means of a remote radio transmitter or manually by a person standing in front of the door (in space 26 or in space 28). Manual operation of door locking means 32 involves manual movement of lock bolt 65 (without changing the position of keeper 63). Manual movement of door 12 between the open and closed positions involves the application of a manual force on the door handle. With clutch 38 in a de-energized condition, screw 40 can rotate freely when a manual force is applied to door 12; the door can be opened or closed without substantially increasing the manual force beyond a so-called normal force. The raised door sill 22 does not appreciably increase the required force, since the drag imposed by the door sill on the sill is removed as soon as the door is out of contact with the door sill.

The door-frame assembly depicted in FIG. 1 can be a factory pre-assembled unit shipped to any building site, ready for installation in a single operation. The electrical wiring between programming control unit 85 and the various servo motors can be run through housing 82 and side frames 14 and 16. The door and the deadbolt lock mechanism 62 can be standard commercial components.

It will be seen that the building access structure can be varied as regards component modifications or variants, while still practicing the invention.

What is claimed:

1. A residential or office building entry access structure that is usable by a physically challenged handicap person, comprising:
An upstanding door-support frame, a door hingedly attached to said frame for swinging movement in a horizontal plane, and means for controlling the swinging motion of said door;
Said control means comprising an electrically-operated means for moving the door between a closed position and an open position, and an electrically-operated lock means for retaining the door in the closed position;
Said electrically-operated lock means comprising a movable locking bolt carried by the door and a retractable keeper carried by the door frame; whereby the locking bolt is prevented from retaining the door in the closed position when the keeper is in the retracted position.

2. The entry access structure of claim 1, wherein said locking bolt is movable in the major plane of the door between an extended position projecting from the door and a retracted position located within the door; said retractable keeper being movable in a plane that is normal to the door major plane when the door is in the closed position.

3. The entry access structure of claim 2, wherein said electrically-operated lock means comprises a reversible electric motor having a drive connection with said retractable keeper, whereby movement of said reversible motor in one direction moves the keeper to a retracted position separated from the locking bolt, and movement of said reversible motor in the opposite direction moves the keeper to an operating position engageable with the locking bolt.

4. The entry access structure of claim 3, wherein said keeper has a notch having a shape conforming to the cross section of the associated locking bolt, so that when the keeper is in the operating position the notch is enabled to partially encircle the locking bolt.

5. The entry access structure of claim 4, wherein said keeper comprises a flat disk that is movable in the disk plane between the retracted position and the operating position.

6. The entry access structure of claim 5, wherein the notch is formed in an edge of said flat disk.

7. The entry access structure of claim 3 wherein said keeper has a cam surface engageable with a locking bolt surface to shift the door in the door-closing direction as said keeper moves from the retracted position toward the operating position.

8. The entry access structure of claim 1, wherein said door-moving means comprises a power-operated screw located on the door-support frame above the swing plane of the door, a lever movable in a horizontal arc below said screw, a nut movable along said screw, a slidable pivot means connecting said nut to said lever whereby the lever swings in a horizontal arc as the nut travels along the screw, an arm structure extending from the door near the door upper edge, and a pivotable link between said lever and said arm, whereby the door is opened or closed in response to rotation of the power-operated screw.

9. The entry access structure of claim 2, and further comprising a housing for said door-moving means; said housing comprising a horizontal elongated box containing said power-operated screw; said door-moving means comprising a bi-directional motor located within said box, and a power-transmitting clutch connecting said bi-directional motor to said screw.

10. The entry access structure of claim 1, and further comprising a sill having a sealing connection with the lower edge of said door; and power-operated means for moving said sill between a raised position engaged with the door and a lowered position facilitating wheelchair movement through the door opening.

11. The entry access structure of claim 10, wherein said sill-moving means comprises a motor-operated screw, cam means movable along the screw axis in response to screw rotation, and cam follower means slidable on said cam means for raising or lowering the sill, depending on the screw rotational direction.

12. A building entry access structure that is usable by a wheelchair occupant, comprising:
an upstanding door-support frame, a door hingedly attached to said frame for swinging movement in a horizontal plane, a door sill connected to said frame below the door swing plane;
an electrically-operated means for moving the door between a closed position and an open position; an electrically-operated lock means for retaining the door in the closed position; an electrically-operated means for moving the sill between a raised position engaged with the door and a lowered position facilitating wheelchair movement through the door opening; and
electrical control means triggered by a radio signal for programming a door-open cycle and a door-close cycle, that involves sequentially moving the lock means to an unlocked condition, lowering the sill out of engagement with the door, moving the door to an open position, generating a time delay for passage of a wheelchair through the door opening, moving the door to a closed position, moving the lock means to a locked condition and raising the sill to a position engaged with the door.

13. The entry access structure of claim 12 wherein said door-moving means comprises a first reversible motor, said lock means comprises a second reversible motor, and said sill-moving means comprises a third reversible motor;
and electrical wiring connecting said second and third motors to said electrical control means; said wiring running within said door-support frame, whereby the entry access structure can be pre-wired prior to installation in a building wall.
